(19) United States
(12) Patent Application Publication
(10) Pub. No.: US 2008/0223689 A1
(43) Pub. Date: Sep. 18, 2008

(54) PULLEY STRUCTURE

(76) Inventor: Ruei-Hsing Lin, Sanchong City (TW)

Correspondence Address: Connolly Bove Lodge & Hutz, LLP, P.O.Box 2207, Wilmington, DE, 19899-2207, US

(21) Appl. No.: 11/686,427

(22) Filed: Mar. 15, 2007

(51) Int. Cl. B65G 13/00

(52) U.S. Cl. 193/37

(57) ABSTRACT

A pulley structure comprises an axle, a ball bearing, a boss and a dustproof cover, in which the axle is connected to the ball bearing, an outside of the ball bearing is covered with the boss, a loop groove is disposed on the boss. Furthermore, a plurality of grooves are disposed on a bottom of the loop groove, a plurality of positioning sheets are extended from a rim of the flange, and the dustproof cover can be tightly engaged with the boss by inserting and sticking the positioning sheets in the grooves. Whereby, the dustproof cover is not easily loosed, and the dustproof object can be attained and foreign matter can be prevented from entering the bearing. Besides, an inner structure of the boss is strengthened to enable it to be shock resistible and not sunken and deformed easily so as to extend the use life of the pulley.

### BACKGROUND OF THE INVENTION

1. Field of the Invention

The present invention relates to a pulley structure, and more particularly to a pulley structure capable of increasing the firmness of a boss thereof.

2. Description of Related Art

Please refer to FIGS. 1 and 2. FIGS. 1 and 2 respectively are exploded and front views of a conventional pulley. A pulley 1 comprises an axle 11, a ball bearing 12, a boss 13 and a dustproof cover, in which the axle 11 is connected onto the ball bearing 12, the boss 13 is used for covering the ball bearing 12, and the boss with a smooth surface allows the pulley 1 to slide easily and protect the ball bearing 12. Furthermore, a loop groove 121 is excavated on the boss 13 with which the dustproof cover 14 can be engaged. A flange 141 is disposed on a rim of the dustproof cover 14 so as to allow the dustproof cover 14 to be inserted and stuck into the groove 131 on the boss 13 to prevent dust from entering gaps of the ball bearing 12. But because the groove 131 is a 360 degree deep groove excavated on the boss 13 to allow the dustproof cover 14 with the flange 141 to be inserted in, the dustproof cover 14 is liable to be thrust to deform when the pulley 1 is slid on a track after being put on weight, and even squeezed and extracted to drop down further to hinder the ball bearing 12 to rotate to cause the pulley 1 to be eccentric and worn. More particularly, the pulley 1 is operated usually without being covered with the dustproof cover 14 in some factories; this causes the pulley 1 to be much easier to be sunken, deformed, eccentric and damaged. Because there is no other buckling structure disposed on the flange 141 of the dustproof cover 14 such that the dustproof cover 14 is easily caused to thrust, deform and drop down when the boss 13 is put in use and a force is exerted thereon. Therefore, the groove 131 of the boss 13 is always designed to provide with a deeper depth to allow the dustproof cover 14 to be tightly stuck in the deeper groove 131 to avoid being dropped down. However, when the pulley bears heavy weight in a long term, because the boss 13 is provided with the deeper groove 131, the boss 13 is caused to be lack of a supporting force owing to the indentation, and further to be damaged easily.

### SUMMARY OF THE INVENTION

For solving the deficits mentioned above, the present invention is proposed. The present invention mainly is to dispose a several grooves on a bottom of a groove of a boss and a several positioning sheets extended from a rim of a dustproof cover; it can prevent the boss from being thrust and deformed, and even being squeezed and extracted to drop down and damage without needing to excavate a deep groove by tightly inserting and sticking the positioning sheets of the dustproof cover into the corresponding grooves of the boss.

The main object of the present invention is to provide a pulley structure, allowing a very shallow groove to be disposed on a boss without needing to excavate a 360 degree deep groove on a boss to enable the structure to be firmer to avoid being damaged. For attaining to the object mentioned above, a plurality of grooves are disposed on a bottom of a loop groove, and a plurality of positioning sheets are disposed on a rim of a dustproof cover; the loop type groove is unnecessary to be excavated deeply by inserting and sticking the flange of the dustproof cover into the loop type groove of the boss and allowing the positioning sheets on the flange of the dustproof cover to be inserted into the grooves of the boss; it enables the positioning sheets of the dustproof cover to be tightly inserted and stuck into the corresponding grooves of the boss to prevent the waterproof cover from being squeezed and extracted.

Another object of the present invention is to provide a pulley structure, preventing a boss from being sunken, deformed, eccentric and damaged easily when a force is exerted on it so as to increase the firmness of the boss and extend the use life of the pulley. For attaining to the object mentioned above, a plurality of grooves is separately disposed on a bottom of the loop groove of the boss to allow a supporting rib to be formed between each two adjacent grooves; the supporting ribs are relied on to increase supporting force.

### BRIEF DESCRIPTION OF THE DRAWINGS

The present invention can be more fully understood by reference to the following description and accompanying drawings, in which:

FIG. 1 is an exploded view of a conventional pulley;

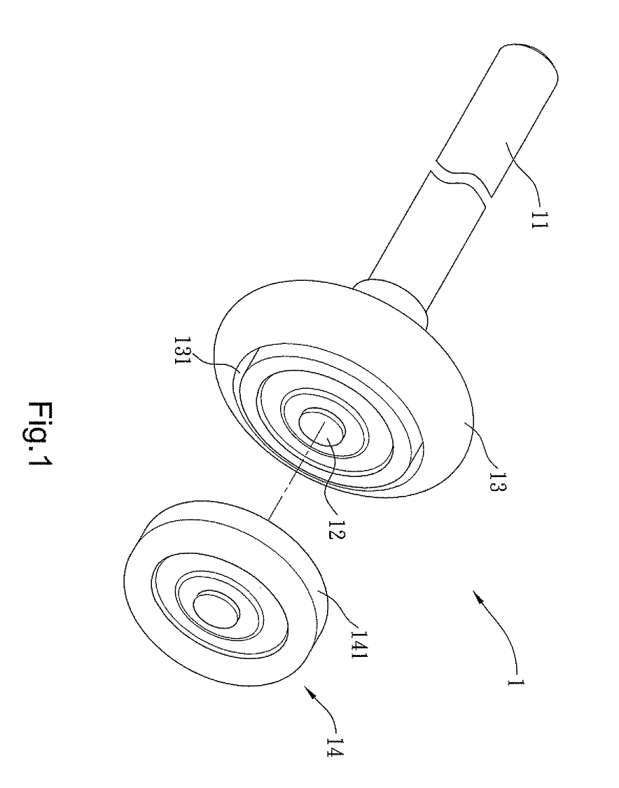

FIG. 2 is a front view of a conventional pulley;

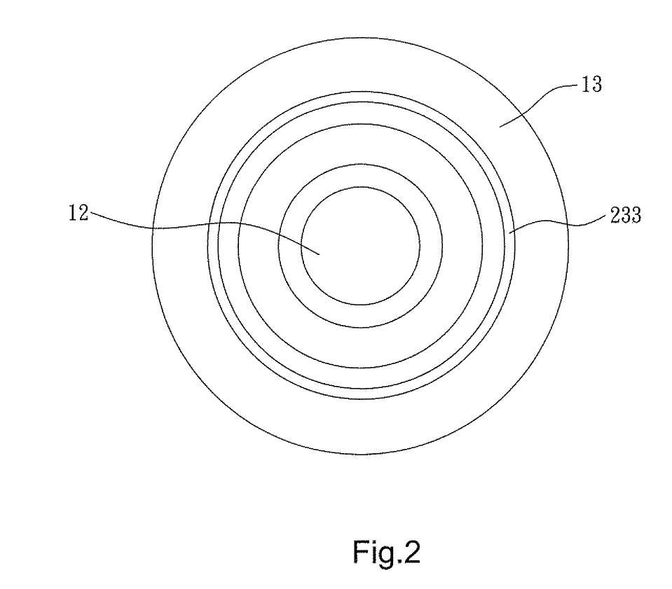

FIG. 3 is an exploded view, showing a pulley structure of a preferred embodiment according to the present invention;

FIG. 4 is a front view, showing a pulley structure of a preferred embodiment according to the present invention; and

FIG. 5 is a cross sectional view, showing a pulley structure of a preferred embodiment according to the present invention.

### DETAILED DESCRIPTION OF THE PREFERRED EMBODIMENTS

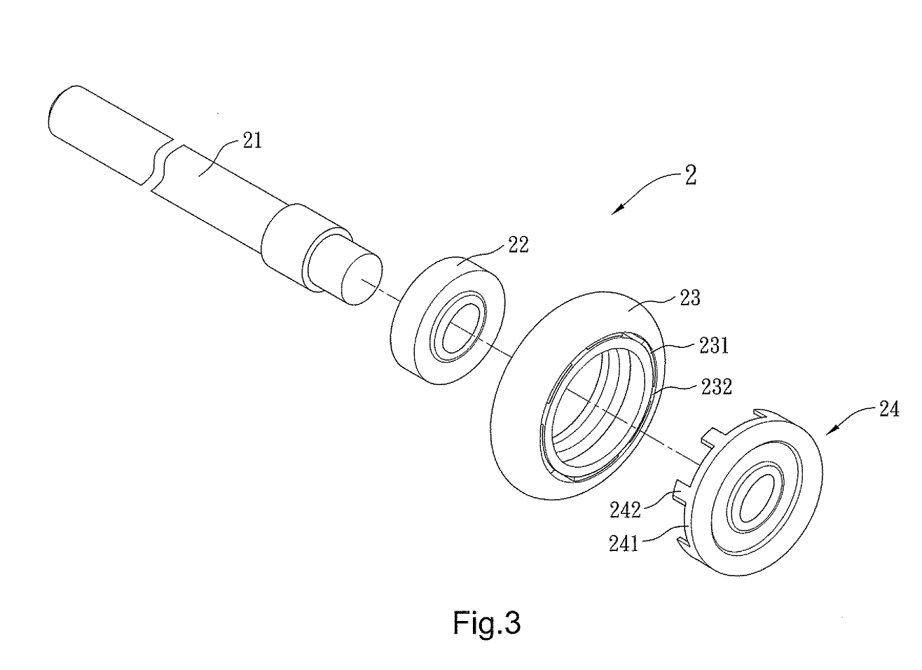

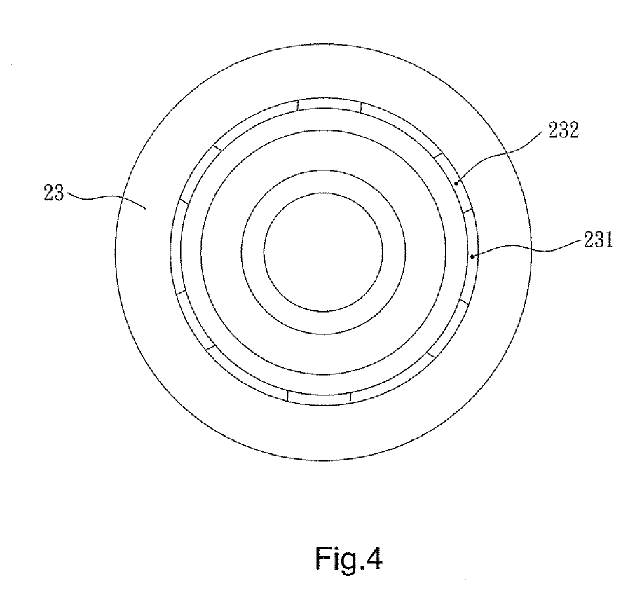

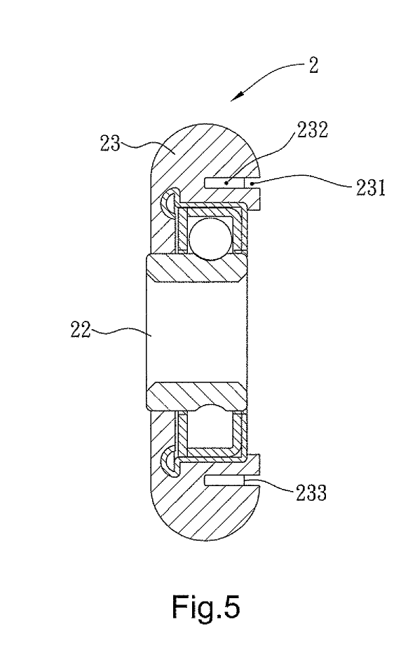

Please refer to FIGS. 3, 4 and 5. FIGS. 3, 4 and 5 are respectively exploded, front and cross sectional views, showing a pulley structure of a preferred embodiment according to the present invention a pulley 2 comprises an axle 21, a ball bearing 22, a boss 23 and a dustproof cover 24, in which the axle 21 is passed through the ball bearing 22, the outside of the ball bearing 22 is covered with the boss 23 and the dustproof cover 24 is engaged with the outside of the boss 23. Furthermore, a loop groove 231 is disposed on the boss 23, a plurality of grooves are equidistantly or not equidistantly disposed on a bottom of the loop groove 231, and a supporting rib 233 is formed between each two adjacent grooves 232. A flange 241 is extended vertically from a rim of the dustproof cover 24, a plurality of positioning sheets 242 are equidistantly or not equidistantly extended from the flange 241 and the positioning sheets 242 are corresponding to the grooves 232 on the boss 23 to allow the positioning sheets 242 of the dustproof cover 24 to be tightly inserted and stuck into the grooves 232 of the boss 23.

From the description mentioned above, the flange 241 of the dustproof cover 24 is allowed to insert and stick into the loop groove 231 of the boss 23 first when the assembly of the boss 23 and the dustproof cover 24 is processed, and the positioning sheets 242 on the flange 241 of the dustproof cover 24 are then inserted into the corresponding grooves 232 of the boss 23; the positioning sheets 242 can exactly tightly be inserted and stuck in the grooves 232 and are not loosed easily. In the meantime, a supporting rib 233 is formed between each two adjacent grooves of the boss 23 to support the boss 23 to prevent the boss 23 from being sunken, deformed, eccentric and damaged, and increase the firmness of the boss 23 and extend the use life of the pulley 2. In particular, when some users need not use the dustproof cover, it is more remarkably shows that the boss structure of the present invention is shock resistible and not sunken, deformed, damaged easily while bearing heavy weight.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. a pulley structure, comprising an axle, a ball bearing, a boss and a dustproof cover; said axle being connected to said ball bearing, an outside of said ball bearing is covered with said boss, a loop groove being disposed on said boss, a flange being disposed on said dustproof cover, and said dustproof cover being installed on said boss by inserting and sticking said flange into said loop groove of said boss; wherein a plurality of grooves are disposed on a bottom of said loop groove, a plurality of positioning sheets are extended from a rim of said flange of said dustproof cover, and said positioning sheets are adapted to insert and stick in said grooves.

2. The pulley structure according to claim 1, wherein said grooves are corresponding to said positioning sheets.

3. The pulley structure according to claim 1, wherein said grooves and said positioning sheets are respectively equidistantly disposed.

4. The pulley structure according to claim 1, wherein said grooves and said positioning sheets are respectively not equidistantly disposed.

5. The pulley structure according to claim 1, wherein each said positioning sheet of said dustproof cover is tightly fitted with said corresponding groove thereof on said boss.
